(19) United States
(12) Patent Application Publication
(10) Pub. No.: US 2025/0244007 A1
(43) Pub. Date: Jul. 31, 2025

(54) LIGHTING DEVICE FOR VEHICLE

(71) Applicant: Honda Motor Co., Ltd., Tokyo (JP)

(72) Inventors: Takato WATANABE, Tokyo (JP); Keishi SHIOMI, Tokyo (JP); Hideaki AIZAWA, Tokyo (JP)

(73) Assignee: Honda Motor Co., Ltd., Tokyo (JP)

(21) Appl. No.: 18/979,673

(22) Filed: Dec. 13, 2024

(30) Foreign Application Priority Data
Jan. 29, 2024 (CN) 202410117426.9

(51) Int. Cl. F21V 31/00; F21S 41/20; F21S 41/29

(52) U.S. Cl. CPC F21V 31/005; F21S 41/2805; F21S 41/29

(57) ABSTRACT

The invention provides a lighting device for a vehicle for which a monitoring device and a light source may be disposed in a same space without being affected by heat and causing failure. The lighting device for the vehicle includes a housing accommodating the light source; and a lens portion covering the housing from an outside of the vehicle to be combined with the housing and forming a lamp chamber surrounded by a sealing portion, wherein the light source is disposed in the lamp chamber, and the monitoring device is disposed at an outside of the lamp chamber and at a position of a back surface of the lens portion.

### CROSS-REFERENCE TO RELATED APPLICATION

This application claims the priority benefit of China application serial no. 202410117426.9 filed on Jan. 29, 2024. The entirety of the above-mentioned patent application is hereby incorporated by reference herein and made a part of this specification.

### BACKGROUND OF THE INVENTION

### Field of the Invention

The invention relates to a lighting device for a vehicle.

### Description of Related Art

In order to also allow vulnerable groups such as the elderly, the disabled, and children to use a sustainable transportation system, the development and the research of autonomous driving techniques and providing transportation having better vehicle safety and convenience are underway. In autonomous driving techniques, how to dispose sensors such as radar and optical radar is very important. In particular, when a device such as a radar is disposed in the same space as the headlights at the front of the vehicle, the device is often affected by the heat generated by the light source, causing failure. In order to solve the issues, the invention aims to improve the safety of autonomous driving techniques, thereby contributing to the development of a sustainable transportation system.

### SUMMARY OF THE INVENTION

The invention relates to a lighting device for a vehicle for which a monitoring device and a light source may be disposed in a same space without being affected by heat and causing failure.

A lighting device for a vehicle of the invention includes a housing accommodating a light source; and a lens portion covering the housing from an outside of the vehicle to be combined with the housing and forming a lamp chamber surrounded by a sealing portion, wherein the light source is disposed in the lamp chamber, and a monitoring device is disposed at an outside of the lamp chamber and at a position of a back surface of the lens portion.

In an embodiment of the invention, the monitoring device is disposed at a monitoring device chamber surrounded by the sealing portion.

In an embodiment of the invention, the monitoring device is disposed at a position other than that surrounded by the sealing portion.

In an embodiment of the invention, the monitoring device is supported at an extending portion extended from the housing.

In an embodiment of the invention, the lens portion has a transparent first portion and an opaque second portion, and the monitoring device is disposed at a position of a back surface of the second portion in the lens portion.

Based on the above, in the lighting device for the vehicle of the invention, the monitoring device is disposed outside the lamp chamber at the position of the back surface of the lens portion. In this way, the monitoring device is separated from the light source as the heat source and is not affected by heat. Accordingly, in the lighting device for the vehicle of the invention, the monitoring device and the light source may be disposed in the same space without being affected by heat and causing failure.

In order to make the above-mentioned features and advantages of the invention more comprehensible, the following specific embodiments are described in detail with reference to the accompanying drawings.

### BRIEF DESCRIPTION OF THE DRAWINGS

FIG. 1 is a three-dimensional schematic view of a lighting device for a vehicle of an embodiment of the invention.

FIG. 2 is a schematic top view of the lighting device for the vehicle in FIG. 1 along the A-A section line.

FIG. 3 is a schematic side view of the lighting device for the vehicle in FIG. 1 along the B-B section line.

FIG. 4 is a schematic view of a modified embodiment of the lighting device for the vehicle of FIG. 3.

### DESCRIPTION OF THE EMBODIMENTS

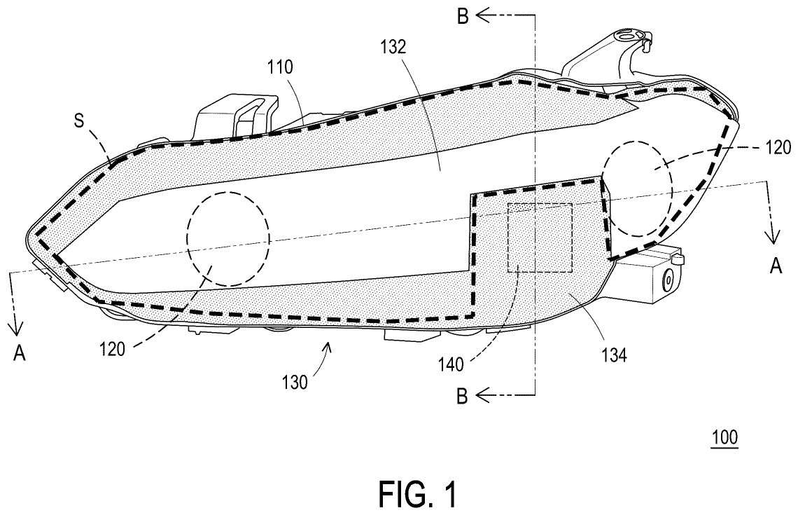

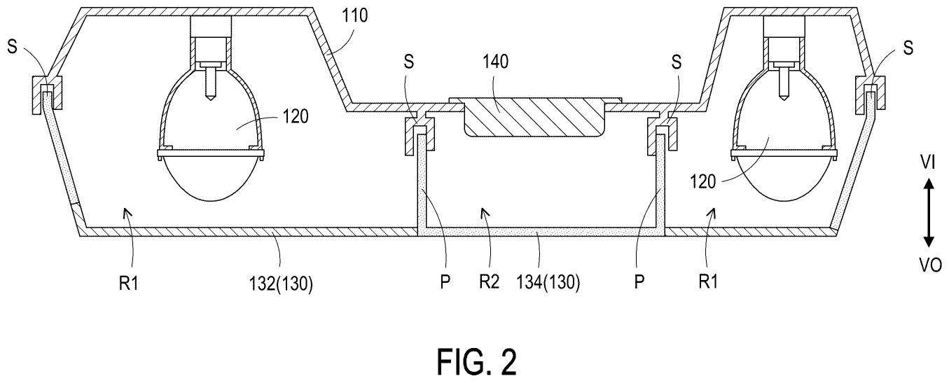

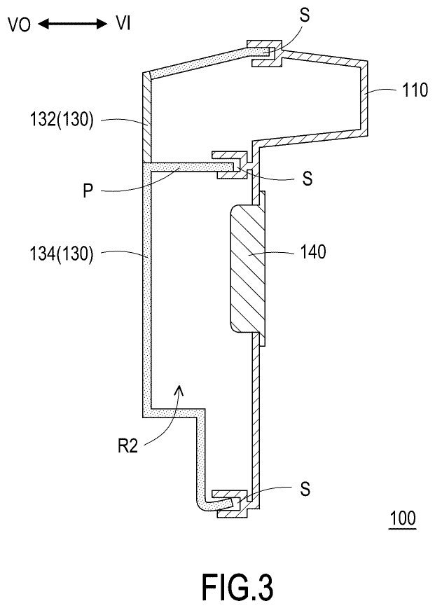

FIG. 1 is a three-dimensional schematic view of a lighting device for a vehicle of an embodiment of the invention. FIG. 2 is a schematic top view of the lighting device for the vehicle in FIG. 1 along the A-A section line. FIG. 3 is a schematic side view of the lighting device for the vehicle in FIG. 1 along the B-B section line. In the present embodiment, a lighting device 100 for a vehicle is, for example, a lighting lamp disposed at the front side of the vehicle for illuminating the road condition. However, the invention is not limited thereto and may also be other similar devices. A vehicle inner side VI, a vehicle outer side VO, etc. in the drawings are not intended to limit the positional relationship of each member in the invention, and the vehicle inner side VI and the vehicle outer side VO are relative and are not defined in terms of actual scope. The specific structure of the lighting device for the vehicle of the present embodiment is described below with reference to FIG. 1 to FIG. 3.

Please refer to FIG. 1 to FIG. 3. In the present embodiment, the lighting device 100 for a vehicle includes a housing 110, a light source 120, and a lens portion 130. The housing 110 accommodates the light source 120, and the lens portion 130 covers the housing 110 from the vehicle outer side VO to be combined with the housing 110. Therefore, the light source 120 is disposed in the space formed by the combination of the housing 110 and the lens portion 130. Furthermore, the lens portion 130 and the housing 110 are coupled via a sealing portion S, and the sealing portion S is disposed substantially along the outer peripheral edge, but the invention is not limited thereto. Furthermore, as shown in FIG. 2 and FIG. 3, a lamp chamber R1 surrounded by the sealing portion S is formed, and the light source 120 is disposed in the lamp chamber R1. More specifically, the lens portion 130 has a partition P protruded toward the vehicle inner side VI, and the partition P is combined with the sealing portion S to surround the space between the housing 110 and the lens portion 130 to form the lamp chamber R1. However, the lamp chamber R1 may also be formed by other methods. The lens portion 130 has a transparent first portion 132 and an opaque second portion 134, and the first portion 132 and the second portion 134 are integrally formed. The monitoring device 140 is disposed at the outside of the lamp chamber R1 and at a position of the back surface of the second portion 134 in the vehicle inner side VI of the lens portion 130, so that the monitoring device 140 is disposed separately from the light source 120. In particular, the monitoring device 140 is, for example, a radar, but may also be a sensor for other vehicles, and the invention is not limited thereto; the second portion 134 is not limited to being opaque, and may also be transparent or translucent.

Therefore, in the lighting device 100 for the vehicle of the present embodiment, the monitoring device 140 is disposed outside the lamp chamber R1 and at a position corresponding to the opaque second portion 134. In this way, the monitoring device 140 is separated from the light source 120 as the heat source without being affected by heat, and the opaque second portion 134 may also block the monitoring device 140 to maintain the aesthetics of the vehicle. Accordingly, in the lighting device 100 for the vehicle of the present embodiment, the monitoring device 140 and the light source 120 may be disposed in the same space without being affected by heat and causing failure.

Furthermore, in the present embodiment, the monitoring device 140 is disposed at a monitoring device chamber R2 surrounded by the sealing portion S. Same as the principle of forming the lamp chamber R1, the partition P on the lens portion 130 is combined with the sealing portion S to surround the space between the housing 110 and the lens portion 130 to form the monitoring device chamber R2. However, the monitoring device chamber R2 may be formed by other methods. The monitoring device chamber R2 corresponds to the second portion 134 of the lens portion 130, that is, the opaque portion, and is formed as a relatively closed space. Therefore, the monitoring device 140 is less likely to be contaminated with dirt such as water, snow, or dust to affect the operation thereof. In other embodiments not shown, the monitoring device 140 does not necessarily need to be disposed on the housing 110, and may also be disposed directly on the vehicle body member, as long as the monitoring device 140 may be covered by the lens portion 130.

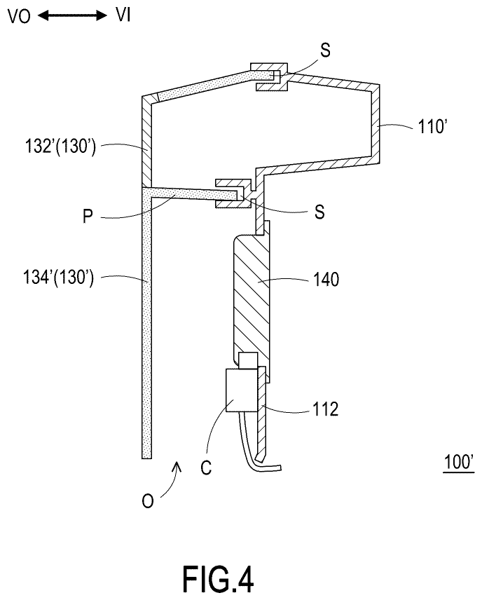

FIG. 4 is a schematic view of a modified embodiment of the lighting device for the vehicle of FIG. 3. In the present modification, a lighting device 100′ for a vehicle is different in that the lighting device 100′ for the vehicle is formed into an open structure. The difference is further described below. The same reference numerals are used in the drawings and the descriptions to represent portions identical or similar to those of the lighting device 100 for the vehicle, and are not described again here.

Please refer to FIG. 4. In the present modification, the monitoring device 140 is disposed at a position other than that surrounded by the sealing portion S. Specifically, a housing 110′ of the lighting device 100′ for the vehicle and a second portion 134′ of a lens portion 130′ are formed into an open type at the lower end of the position of the original monitoring device chamber R2. That is, there is no sealing portion S to seal the lower end and a structure of an opening O is formed. Furthermore, the monitoring device 140 is supported at an extending portion 112 extended from the housing 110′ and is also provided with a connector C. The wiring of the connector C is connected to a device (not shown) of the vehicle inner side VI via the lower opening O. In this way, the heat generated by the monitoring device 140 may be dissipated, and the space of the connector C and the wiring may be ensured via the arrangement of the opening O. Although not shown in the drawings, the lamp chamber R1 formed by the housing 110′ and a first portion 132′ of the lens portion 130′ is still formed as a sealed space by the sealing portion S. Therefore, the monitoring device 140 in the present modification may also isolate the heat from the light source 120 and avoid being affected by the heat. In addition to the lower end, the position of the opening O may also be at the left and right sides (that is, the direction perpendicular to the drawing), as long as heat dissipation and wiring may be facilitated, and the invention is not limited thereto. In other embodiments not shown, the monitoring device 140 does not necessarily need to be disposed on the housing 110′, and may also be disposed directly on the vehicle body member (not shown), as long as the monitoring device 140 may be covered by the lens portion 130′.

Based on the above, in the lighting device for the vehicle of the invention, the monitoring device is disposed outside the lamp chamber and at the position corresponding to the opaque second portion. In this way, the monitoring device is separated from the light source as the heat source without being affected by heat, and the opaque second portion may also block the monitoring device to maintain the aesthetics of the vehicle. Preferably, the monitoring device may also be disposed in the monitoring device chamber to prevent heat sources and foreign objects from entering and affecting the operation. Accordingly, in the lighting device for the vehicle of the invention, the monitoring device and the light source may be disposed in the same space without being affected by heat and causing failure.

Lastly, it should be noted that the above embodiments are used to describe the technical solution of the invention instead of limiting it. Although the invention has been described in detail with reference to each embodiment above, those having ordinary skill in the art should understand that the technical solution recited in each embodiment above may still be modified, or some or all of the technical features thereof may be equivalently replaced. These modifications or replacements do not make the essence of the corresponding technical solutions depart from the scope of the technical solution of each embodiment of the invention.

What is claimed is:

1. A lighting device for a vehicle, comprising:
a housing accommodating a light source; and
a lens portion covering the housing from an outside of the vehicle to be combined with the housing, and forming a lamp chamber surrounded by a sealing portion, wherein
the light source is disposed in the lamp chamber,
a monitoring device is disposed at an outside of the lamp chamber and at a position of a back surface of the lens portion.

2. The lighting device for the vehicle of claim 1, wherein,
the monitoring device is disposed at a monitoring device chamber surrounded by the sealing portion.

3. The lighting device for the vehicle of claim 1, wherein,
the monitoring device is disposed at a position other than that surrounded by the sealing portion.

4. The lighting device for the vehicle of claim 1, wherein,
the monitoring device is supported at an extending portion extended from the housing.

5. The lighting device for the vehicle of claim 1, wherein,
the lens portion has a transparent first portion and an opaque second portion, the monitoring device is disposed at a position of a back surface of the second portion in the lens portion.

6. The lighting device for the vehicle of claim 2, wherein,
the lens portion has a transparent first portion and an opaque second portion, the monitoring device is disposed at a position of a back surface of the second portion in the lens portion.

7. The lighting device for the vehicle of claim 3, wherein,
the lens portion has a transparent first portion and an opaque second portion, the monitoring device is disposed at a position of a back surface of the second portion in the lens portion.

8. The lighting device for the vehicle of claim 4, wherein,
the lens portion has a transparent first portion and an opaque second portion, the monitoring device is disposed at a position of a back surface of the second portion in the lens portion.
